(19) United States
(12) Patent Application Publication
(10) Pub. No.: US 2005/0151335 A1
(43) Pub. Date: Jul. 14, 2005

(54) Method and apparatus for transporting and storing tires

(76) Inventor: Ronnald B. King, Spokane, WA (US)

Correspondence Address: WEIDE & MILLER, LTD., 7251 W. LAKE MEAD BLVD., SUITE 530, LAS VEGAS, NV, 89128, US

(21) Appl. No.: 11/061,186

(22) Filed: Feb. 17, 2005

(30) Foreign Application Priority Data
Aug. 20, 2003 (WO) PCT/US03/26199

(51) Int. Cl. B62B 5/00

(52) U.S. Cl. 280/79.4

(57) ABSTRACT

An apparatus for transporting and storing one or more tires includes at least one container. The container includes mating first and second sections for enclosing a tire. The first and second sections may be connected. In one embodiment, the apparatus includes a plurality of containers for storing a plurality of tires. The containers are configured to engage one another to retain them in a vertical configuration when they are stacked upon one another. In one embodiment, the containers are stacked upon a wheeled platform or the lower-most container includes wheels, permitting the stored tire or tires to be transported by rolling.

### RELATED APPLICATIONS

his application claims priority to PCT/US2003/026199, filed Aug. 20, 2003, which claims priority to U.S. Provisional Application Ser. No. 60/442,223, filed Jan. 23, 2003 and U.S. application Ser. No. 10/224,769, filed Aug. 20, 2002.

### FIELD OF THE INVENTION

The present invention relates to methods and devices for transporting and storing tires such as those used on cars and trucks.

### BACKGROUND OF THE INVENTION

Tires are commonly encountered objects. They are used on a variety of vehicles, such as automobiles, and frequently need to be changed. Tires come in a variety of shapes, sizes and specifications, and may differ substantially depending on their particular design. Snow tires, for example, are specially configured for use in winter driving conditions. These tires are, however, not particularly desirable when primary driving occurs during warmer spring/summer months. As such, the owner of a vehicle may wish to own several sets of different tires and utilize specific tires designed for particular purposes.

When not used, tires require storage. For example, while not in use during summer months, snow tires must be stored. In addition, tires may need to be transported, such as to or from a tire service center or from one area of a car garage to another. The transport and storage of tires are inconvenient, difficult and dirty tasks, but the need to perform these tasks arises in a variety of situations.

The transport and storage of tires is difficult for a number of reasons. One reason is that, especially when mounted to a supporting wheel, automobile and truck tires can be rather heavy and awkward to handle. Another problem is that tires are round. While the opportunity exists to roll tires in order to transport them, they may quickly pick up speed and roll out of control. The fact that tires can easily roll also makes their storage difficult, as they may roll about a garage.

Tires which are stored also pose safety problems. Stacked tires are often unstable and may tip over, causing damage or injury.

Another problem is that tires are often very dirty. Snow tires used throughout the winter may be covered with mud, brake dust, grease, oil, salt or other material. This material may rub off onto a person or surrounding objects.

Another problem is that tires can break down or be damaged when exposed to sunlight, weather, chemicals, or other destructive elements.

A method and apparatus which provides for convenient, effective and easy transport and storage of tires is desired.

### SUMMARY OF THE INVENTION

The invention is a method and apparatus for transporting and storing one or more tires. In one embodiment of the invention, the apparatus includes at least one container for housing at least one tire.

In one embodiment, the container comprises first section and second section. When connected, the first and second sections define an interior space within which one or more tires may be located. In one form, the first and second sections include a generally circular base portion with a wall extending upwardly from the periphery of the base portion, thus defining a generally cylindrical element. When connected, the walls of the first and second sections overlap.

The container may include means for connecting the first and second sections. In one embodiment, the means for connecting includes at least one projection located on an inner surface of the wall of one section and at least one depression located on the outer surface of the other section. In one embodiment, the projection comprises a generally annular rib and the depression comprises a generally annular trough.

Preferably, a plurality of tires are located in individual containers. The containers are stacked in a vertical arrangement. In one embodiment, the apparatus includes means for connecting the containers. In one embodiment, the means comprises at least one projection on one container for engagement with at least one depression in another container. In one embodiment, one or more raised dimples extend from the bottom of one container for location in mating depressions in the top of another container.

In one embodiment, the apparatus includes means for supporting one or more of the containers in a manner by which they are portable, such as by rolling them. In one embodiment, one or more containers are supported on a wheeled platform. In another embodiment, one or more of the containers are provided with casters or wheels. Preferably, the lower-most container has wheels, with the remaining containers stacked there upon.

In one embodiment, each container includes at least one handle. The handle may be used to pull the vertically stacked containers or carry each container in a suit-case like fashion. In another embodiment, a flat spot or one or more feet, legs or other support elements may be located opposite the handle upon which the container may be rested in an upright or vertical position.

In one embodiment, each container includes a hanger or hanging element permitting the container to be mounted to a support, such as secured with a hook extending from a wall. Each container may also include wheels or rollers which permit transport of the container in its upright or vertical position. In one embodiment, the container may include a handle which may be retracted for storage and extended for use.

In another embodiment, the containers are constructed in whole or in part of a playable material, such as a fabric. A portion, such as a top or bottom, may be constructed as a rigid plastic disc. A zipper or hook and loop fastening material may be used to join top and bottom sections of each container, permitting the container to be opened or closed.

In accordance with the invention, tires are conveniently stored in one or more containers. So stored, tires are prevented from contacting, soiling and damaging other items or people. Tires may also easily be transported in their containers, such as by grasping the handle and transporting them in suitcase-like fashion. In addition, one or more tires may be rolled from location to location within their containers using the casters or wheels.

Further objects, features, and advantages of the present invention over the prior art will become apparent from the detailed description of the drawings which follows, when considered with the attached figures.

### DESCRIPTION OF THE DRAWINGS

FIG. 1 is a side plan view of a tire transport and storage apparatus in accordance with an embodiment of the present invention, the tire transport and storage apparatus including a plurality of individual tire storage containers;

FIG. 2 is a cross-sectional view of a tire transport and storage container illustrated in FIG. 1 taken along line 2-2 therein;

FIG. 3 is a cross-sectional view of a tire transport and storage container in accordance with another embodiment of the invention;

FIG. 4 is a top view of the tire transport and storage container illustrated in FIG. 2 taken in the direction of arrows 4-4;

FIG. 5 is a top view of the tire transport and storage container illustrated in FIG. 3 taken in the direction of arrows 5-5;

FIG. 6 is a side plan view of a tire transport and storage apparatus in accordance with another embodiment of the invention;

FIG. 7 is a cross-sectional view of the tire transport and storage container of the apparatus illustrated in FIG. 6 taken along line 7-7 therein;

FIG. 8A illustrates yet another tire transport and storage apparatus in accordance with the invention in a retracted or open position;

FIG. 8B illustrates the tire transport and storage apparatus illustrated in FIG. 8A in a closed position;

FIG. 9 illustrates yet another embodiment of a tire transport and storage apparatus in accordance with the invention;

FIG. 10 illustrates yet another embodiment of a tire transport and storage apparatus in accordance with the invention;

FIG. 11 illustrates yet another embodiment of a tire transport and storage apparatus in accordance with the invention;

FIG. 12 illustrates yet another embodiment of a tire transport and storage apparatus in accordance with the invention;

FIG. 13A illustrates one embodiment of a mounting configuration for a tire transport and storage apparatus in accordance with the invention;

FIG. 13B illustrates another embodiment of a mounting configuration for a tire transport and storage apparatus in accordance with the invention;

FIG. 14 illustrates yet another tire transport and storage apparatus in accordance with an embodiment of the present invention, the apparatus including individual containers constructed of a flexible or playable material;

FIG. 15A illustrates yet another tire transport and storage apparatus in accordance with an embodiment of the present invention, the apparatus including containers partially constructed of a flexible or playable material, the containers illustrated in an expanded position holding a tire;

FIG. 15B illustrates the containers in FIG. 15A in a collapsed state; and

FIG. 16 illustrates yet another tire transport and storage apparatus in accordance with an embodiment of the present invention.

### DETAILED DESCRIPTION OF THE INVENTION

The invention is a method and apparatus for transporting and storing one or more tires. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a method and apparatus for transporting and storing one or more tires. The invention comprises at least one container for containing or housing one or more tires. In one embodiment, the invention comprises a tire transport and storage apparatus which includes one or more containers for transporting and storing one or more tires. Rollers or other means may be provided in association with at least one container for permitting the container to be transported, such as by rolling.

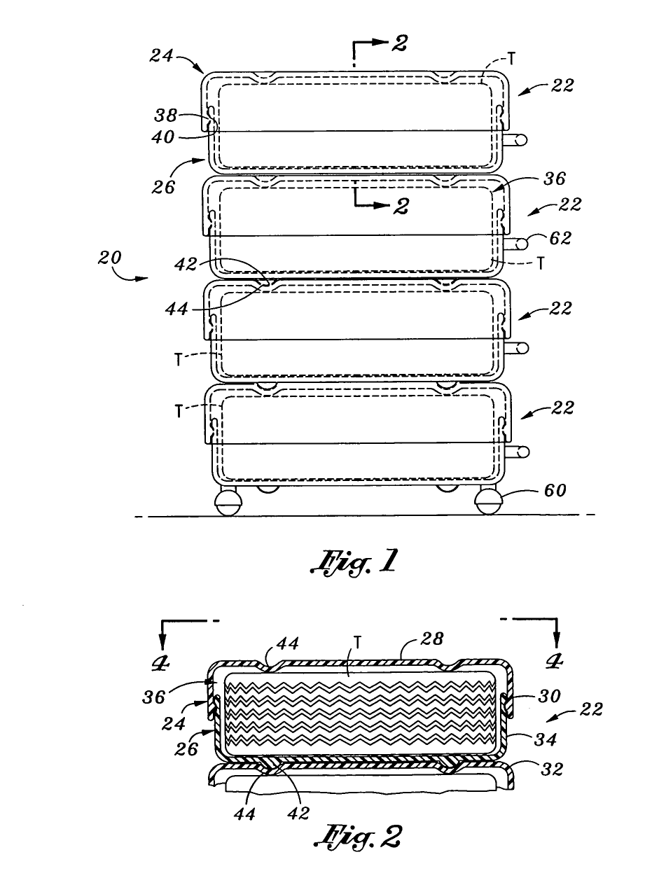

One embodiment of a tire transport and storage apparatus 20 in accordance with the invention is illustrated in FIG. 1. In the embodiment illustrated, the apparatus 20 comprises a plurality of individual tire transport and storage containers 22.

In general, each container 22 is configured to house a single tire T. Referring to FIGS. 1 and 2, in one embodiment each container 22 comprises a mating first section or portion 24 and second section or portion 26. In the position illustrated, the first section 24 may be referred to as the “top” portion of the container 22, while the second section 26 may be referred to as the “bottom” portion of the container 22. It will be appreciated, however, that if the position of the container 22 were inverted, the second section 26 would be the “top” of the container 22 and the first section 24 the “bottom” of the container 22.

The first section 24 has a generally circular base portion 28. A wall 30 extends outwardly from the base portion 26, generally perpendicular thereto. When the base portion 28 is generally circular, the wall 30 extends in a generally circular periphery. When the container 22 is in the position illustrated, the base portion 28 of the first section 24 forms the “top” of the container 22.

Likewise, the second or bottom section 26 has a generally circular base portion 32. A wall 34 extends outwardly from the base portion 32, generally perpendicular thereto. When the container 22 is in the position illustrated, the base portion 32 of the second section 26 forms the “bottom” of the container 22.

The first section 24, including both the base portion 28 and wall 30, has an inner surface and an outer surface. Likewise, the second section 26, including both the base portion 32 and wall 34, has an inner surface and an outer surface.

Sizes and shapes of the first section 24 and second section 26 may vary. In the configuration illustrated and just described, the first and second sections 24,26 are generally cylindrical in shape, having one closed end. In other embodiments, the first and second sections 24,26 may have other shapes. For example, the base portion of the first and second sections 24,26 may be square.

In the embodiment illustrated where the first and second sections 24,26 are cylinder shaped, the diameter of the first section 24 preferably slightly exceeds the diameter of the second section 26, permitting the wall 30 of the first section 24 to overlap the wall 34 of the second section 26, as best illustrated in FIG. 2. In another embodiment, the second section 26 may overlap the first section 24.

In one embodiment, the diameter of the first and second sections 24,26 is between about 12 and 48 inches each. The size of the first and second sections 24,26 may vary, however, dependent upon the size of the tire to be housed.

The distance by which the wall 30 of the first section 24 and the wall 34 of the second section 26 extend outwardly from their respective base 28,32 may also vary. Preferably, the walls 30,34 extend outwardly a sufficient distance such that the walls 30,34 overlap when tires of various widths are placed in the container. In one embodiment, the walls 30,34 extend outwardly about 4 to 24 inches each. Once again, this distance may vary dependent upon the size of the tire or tires to be housed. For example, for wider tires, one or both walls 30,34 must extend outwardly a greater distance.

The first and second sections 24,26 may be constructed of a variety of materials. In one embodiment, the first and second sections 24,26 are constructed of a durable, weather resistant material such as plastic, polyethylene or the like. In one embodiment, the first and second sections 24,26 are constructed of a material causing them to be generally rigid. In one embodiment, the first and second sections 24,26 may be constructed by molding them of a plastic material.

Use of the container 22 of the invention will be described in detail below. In general, however, the first and second sections 24,26 may be connected to define an interior space 36 in which one or more tires may be housed.

In one embodiment, a connecting mechanism or other means is provided for connecting the first and second sections 24,26. In one embodiment, this means comprises one or more protrusions extending from one of the sections for engagement with one or more depressions located on the other section.

Referring to FIGS. 1 and 2, in one embodiment the protrusion comprises a rib 38 extending from the inner surface of the wall 30 of the first section 24. The depression comprises a trough 40 located in the outer surface of the second section 26. In other embodiments, there may be more than one rib and/or more than one trough. Further, the one or more ribs may be located on the second section 26 and the one or more troughs located in the first section 24. The protrusions and depressions may comprise other elements, such as dimples for mating with craters or protrusions and depressions of other shapes allowing the sections 24,26 to be securely connected.

In one embodiment, the means for connecting permits the first and second sections 24,26 to be connected in a variety of positions. In one embodiment, a plurality of troughs may be formed in the second section 26. The troughs are spaced along the wall 34, permitting the one or more ribs on the first section 24 to engage the second section 26 in various positions.

Other means may be provided for connecting the first and second sections 24,26. In one embodiment, this means may simply comprise friction between engaging surfaces of the walls 30,34 of the sections 24,26. Other means such as snaps, clamps, ties, or the like may be used. For example, rotating clamps may be connected to one section for engaging a catch located on the other section.

In a preferred embodiment of the invention, the apparatus 20 includes a plurality of containers 22. In this manner, the apparatus is configured to house or store a plurality of tires. In a preferred embodiment, the containers 22 are configured to be stacked upon one another in a vertical relationship. In one embodiment, means are provided for connecting one or more containers 22 when in their stacked configuration.

FIGS. 1-2 and 4 illustrate one embodiment of a means for connecting the containers 22. As illustrated, one or more protrusions extend from one container 22 for engagement with one or more depressions location in another container 22. In one embodiment, a plurality of dimple or dome-shaped protrusions 42 extend from the base 32 of the bottom section 32 of the container 22. A plurality of crater-shaped depressions 44 are located in the base 28 of the first section 24 of the container 22. As illustrated, when stacked, the protrusions 42 extending from one container 22 are adapted to engage the depressions 44 of a container 22 positioned below it. In this configuration, the top and bottom of adjacent containers 22 are connected to one another.

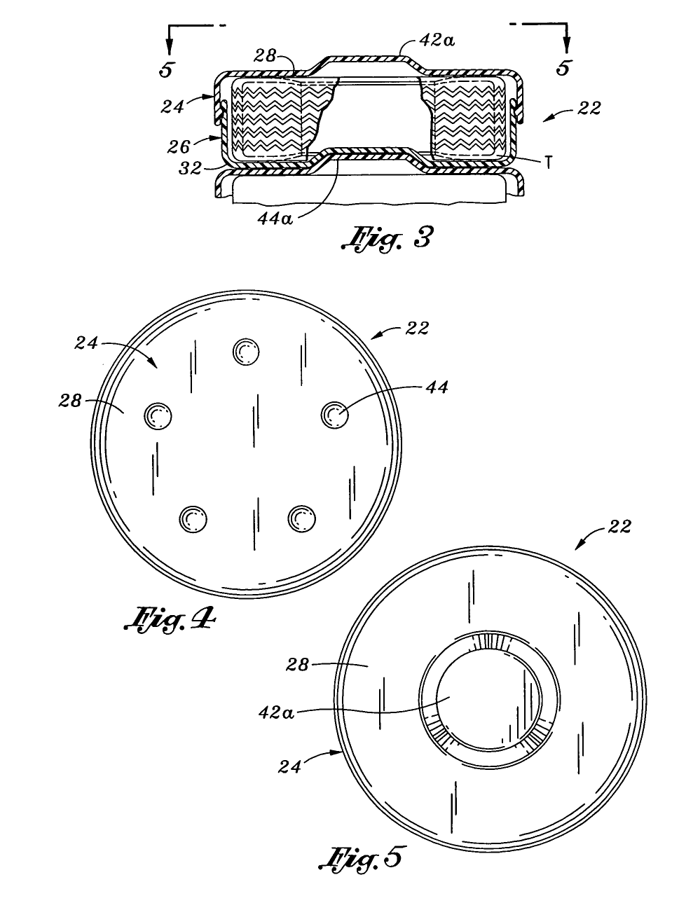

The one or more protrusions and one or more depressions may have a variety of shapes and configurations. Another embodiment of the means for connecting is illustrated in FIGS. 3 and 5. As illustrated, a single large protrusion 42a extends upwardly from the base 28 of the first section 24 of each container 22. A mating depression 44a is formed in the base 32 of the second section 26 of the container 22. The protrusion 42a of one container 22 is configured to mate with the depression 44a of another container 22 as illustrated.

An additional advantage of this embodiment design is illustrated in FIG. 3. As is known, tires and most tires mounted upon a wheel include a central generally circular open section. In the embodiment illustrated, the base portion 32 of the second section 26 extends upwardly to define the depression 44a. This portion of the base portion 32 extends into the central open section of a tire or tire/wheel combination, centering the tire and maintaining it in position within the container 22.

There may be more than one protrusion and more than one depression, and their number and location may vary. The protrusion(s) may comprise one or more ribs or other elements, and the depression(s) one or more troughs or other elements. Preferably, the means for connecting inhibits the relative movement of stacked containers 22, particularly in the side-to-side direction. For example, as illustrated in FIG. 11, in one embodiment, an outer or peripheral ridge 42a located on one container 22 may be configured to mate with a corresponding trough 44a on another container 22.

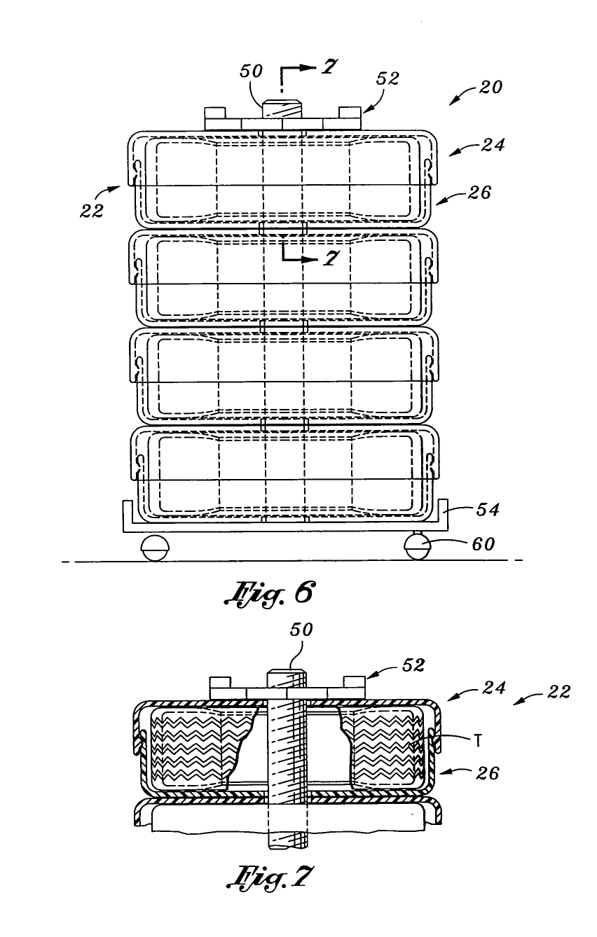

Other means may be provided for connecting two or more containers 22. FIGS. 6 and 7 illustrate yet another of these means. As illustrated, this means comprises a post 50 and a locking member 52. As described above, tires and tires mounted upon wheels generally have one or more openings there through. These openings may comprise, for example, a central bearing or cap opening, or offset lug bolt openings. In accordance with one embodiment of the invention, the top and bottom sections 24,26 of the container 22 have one or more openings there through. A post 50 is extended through the openings in the containers 22 and the opening or openings in the tires/wheels. As illustrated in FIG. 6, the post 50 is generally centrally extending through the center of the tires T.

In one embodiment, the post 50 is mounted to a support structure. As illustrated, the support structure may comprise a platform 54.

Containers 22 containing tires T are stacked upon one another on the platform 54 with the post 50 passing there through. It will be appreciated that in this arrangement alone, movement of the containers 22 in the horizontal direction is substantially limited. In one embodiment, however, additional means are provided for retaining the containers 22 in position.

In one embodiment, at least a portion of the post 50 is threaded. The locking member 52 engages the post 50. The locking member 52 may be threaded along the post 50 until it engages the top container 22. The locking member 52 is preferably sized and shaped to prevent the containers 22 from being lifted off of the post 50 without first removing the locking member 52. In addition, if the locking member 52 is threaded downwardly a sufficient distance, it may engage the top-most container 22 and transmit a force through the containers 22 which further prevents their movement in the horizontal direction.

Other means may be used to lock or secure the one or more containers 22 to the post 50. For example, the post 50 may have a plurality of openings there through. A cotter pin, rod or the like may be passed through the post 50 into engagement with the post 50 in a desired position along the post 50.

The post 50 may comprise a slender rod which is configured to pass through the tires T or, when mounted upon wheels, the lug openings in the wheels. In one embodiment, more than one rod may be provided, the rods passing through different openings.

Other means may be provided for securing the containers 22 to one another. For example, straps, latches, ties, or the like may be used to connect the containers 22.

In one embodiment, means are provided for moving one or more containers 22. Preferably, the means comprises a means for supporting and moving the containers 22 by rolling. Referring to FIG. 1, in one embodiment a plurality of casters 60 are connected to one of the containers 22 of the apparatus 20. The casters 60 may have a variety of forms and may comprise wheels, bearings or one or more other elements permitting portability of the one or more containers 22.

Preferably, in one embodiment the apparatus 20 includes a plurality of containers 22 with a single container 22 including the casters 60. In this embodiment, the container 22 including the casters 60 is located on the bottom when the containers 22 are stacked.

In one embodiment, as illustrated in FIG. 6, the means may include a support for the containers, the support being configured in a manner allowing it to be rolled. In one embodiment, the support comprises the platform 54 as illustrated. One or more casters 60 are connected to the platform 54, thus permitting the platform to the rolled. The platform 54 may be configured to be rolled in other fashions, including with wheels, rollers or the like. The platform 54 may be of a variety of shapes and sizes.

In one embodiment, the casters 60, rollers or the like may be removable. For example, each container 22 may include a plurality of apertures for accepting the stem of a caster 60. The user may then attach or detach casters 60 to any of the containers 22. The platform 54 or other support may be similarly configured.

In one embodiment, at least one container 22 of the apparatus 20 includes a handle 62. As illustrated in FIG. 1, a handle 62 may extend from each container 22. In one embodiment, the handle 62 extends from the second section 26 of the container 22. The handle 62 may comprise a member which is connected to the container 22 or be molded in and form a portion of the container 22. In one embodiment, the handle 62 defines a gripping portion and an opening between the gripping portion and the container 22 through which a portion of a user's hand may be extended when grasping the handle 62.

The handle 62 may have other forms. For example, the handle may comprise a looped strap or the like.

In one preferred embodiment, each container 22 is specifically configured so that it may be stored or placed in an upright position. In one embodiment, each container 22 has a generally flat or planar area, or one or more feet, legs or other support elements positioned generally opposite the handle 62. In this configuration, a user may set the container 22 in an upright position on the planar portion or feet, legs or other support elements.

The use of the tire transport and storage apparatus 20 in accordance with the invention will now be described. In accordance with the invention, a container is provided for housing one or more tires T, and an apparatus is provided for transporting and storing one or more tires.

In one embodiment, referring to FIG. 1, a tire may be stored in a container 22. The first and second sections 24,26 of the container 22 are separated. In one embodiment, the second section 26 of the container 22 is placed upon a supporting surface, such as platform 54 or another container 22. A tire is then located within an area defined by the second section 26. The first section 24 is then connected to the second section 26 to enclose the tire T within an interior space 26 defined by the mating first and second sections 24,26.

A tire T may be located in the container 22 in other manners. For example, a tire may be located in the space defined by the first section 24. The second section 26 may then be connected to the first section.

As used herein, the term “tire” may refer to a tire alone or a tire mounted upon a wheel. The tire or tire/wheel may include a hub cap, valve stem and other features.

As indicated, in order to enclose the tire T in the container 22, the first and second sections 24,26 are connected to one another. In one embodiment, this step comprises lowering the first section 24 over the second section 26. As described above, this preferably results in the wall 30 of the first section 24 overlapping the wall 34 of the second section 26.

Preferably, this step includes the step of connecting the first and second sections 24,26 with the means for connecting. In one embodiment, this step comprises engaging the one or more ribs 28 on the first section 24 with the one or more troughs 40 on the second section. In a preferred embodiment, the first section 24 is lowered until at least a portion of the base 38 thereof engages the tire or wheel.

In accordance with the invention, one or more tires T may be stored using one or more containers 22. The one or more tires T are located in the one or more containers 22 in the manner just described.

In one embodiment of the invention, the apparatus 20 comprises a plurality of containers and the method of use of the apparatus 20 includes connecting or linking the containers 22. As illustrated in FIGS. 1 and 2, in one embodiment the containers 22 are vertically stacked. Thus, in accordance with the method of use, the user stacks containers 22 containing tires T. For example, as illustrated, a user may store four tires T by locating each of the tires T in a single container 22 and stacking the containers. Of course, the containers 22 need not be loaded and then stacked, but may be loaded as they are stacked.

As illustrated, in one embodiment, the containers 22 are stacked in a manner utilizing the means for connecting the containers 22. In the embodiment illustrated in FIGS. 1-2 and 4, this comprises aligning the protrusions 42 extending from the base 32 of the second section 26 of one container 22 with the depressions 44 formed in the base 28 of the first section 24 of a mating container 22. In the embodiment illustrated in FIGS. 3 and 5, this comprises aligning the single protrusion extending from the second section 26 of one container 22 with the depression formed in the first section 24 of a mating container 22.

Once a tire or tires are housed, they may be easily transported in the container 22. In one embodiment, the tire or tires may be transported by carrying them in the container 22 in a suitcase like manner. In this arrangement, a user grasps the handle 62 and picks up the container 22 to transport it.

As illustrated, the containers 22 may be stacked in succession. In the embodiment illustrated, four tires T are stored by locating them in four stacked containers 22.

The containers 22 may be stacked in a variety of fashions. In a preferred embodiment, when one of the containers 22 is provided with casters 60, that container 22 is located on the bottom of the stack. Once that container 22 is filled, the second section 26 of the next container 22 may be located on the first container. A tire T may be located in that portion of the container 22, and then the first section 24 connected to the second section 26, and so on until all the tires T have been housed and stacked.

In accordance with the invention, the method of use includes moving the tires T. In a preferred embodiment, the tires may be transported by locating them in the containers 22. In the embodiment illustrated in FIG. 1, the stacked containers 22 may be rolled upon the casters 60 about a surface.

A user may grasp one of the handles 62 in order to move a container 22 or to move the entire stack of containers 22. The user may engage other surfaces, such as the top container 22, in order to move the stack of containers.

The method of using the apparatus illustrated in FIGS. 6 and 7 is similar to that described above. In this embodiment, however, the containers 22 are located on the pole 50. In particular, the user passes the pole 50 through each section of each container 22, as well as the tire which is housed by each container. The user then secures the containers 22 to one another using the locking member 52. As described above, the locking member 52 may be threaded upon the post 50 until it engages the top-most container 22.

In this embodiment, transport or movement of the containers 22 is generally the same. In this embodiment, the containers 22 are moved by rolling the apparatus 20, including the platform 54, about a surface using the casters 60.

The apparatus of the invention has numerous advantages which will now be appreciated. In accordance with the invention, an apparatus is provided for transporting and storing or housing one or more tires. In accordance with the invention, one or more tires are located within one or more generally enclosed containers or housings. The one or more containers prevent the one or more tires from contacting people and other items, and thus prevents the one or more tires from transferring dirt or the like. In the event the one or more tires are studded snow tires, the container prevents the studs from snagging items such as a person's clothing. Because the one or more tires are enclosed, the container enclosing the one or more tires may be located in a garage where it may otherwise be undesirable to store the tire(s).

Most importantly, the one or more tires are safely stored. In particular, the tire or tires are stacked in a secure fashion, preventing them from rolling or tipping over, thus preventing damage or injury. As may be appreciated, tires may form the basis of liability for a homeowner. As indicated above, the tires may roll out of control from a garage and hit a person or property causing damage or injury. Alternatively, stacked tires may tip over. Tires may also soil another person's clothes or the like. In accordance with the invention, one or more tires may be securely and safely stored in a manner reducing the likelihood of these accidents.

In accordance with the invention, the container houses the one or more tires in an aesthetically pleasing fashion. When assembled and stacked, the containers present an organized and pleasing storage apparatus.

Once stored in their containers, tires are protected from the elements. For example, the tires are protected from sunlight, rain, chemicals and other elements which may damage the tires if they were exposed to such during storage.

A particular advantage of the invention is that a plurality of individually housed or stored tires may be stacked. The stacked arrangement of the stored tires minimizes occupied space. As is known, in garages and similar locations, vertical space is often available, while horizontal space is at a premium. In accordance with the invention, the horizontal space occupied by the apparatus is minimized by storing the tires in a stacked or vertical arrangement.

In accordance with the invention, one or more tires may be easily transported. First, a container may be transported using the handle of that container, in a suitcase-like fashion. As one example, a party may need to transport a flat tire to a tire service center. The party may carry the tire housed in a container to their car using the handle. The tire is not only easily transported, but the user is protected from the tire soiling their car, body or clothes. In addition, the party may easily load the tire into their car for transport. The tire is prevented from rolling about inside their car while traveling, and their car is also protected from damage, such as from soiling or the like.

The one or more tires may also be transported using the rollers or the other means for moving. In a preferred embodiment, one or more tires may be moved by locating them in one or more containers including the casters or wheels, or by locating the one or more containers upon the platform having casters or wheels. In one embodiment, a plurality of tires are placed in containers which are stacked. The entire stack is then moved using the casters or wheels. In this manner, one or more tires are conveniently moved.

A variety of other embodiments of apparatus are contemplated. In one embodiment, the container of the invention may be configured to house more than one tire. For example, the container may comprise a tall cylinder in which two or more tires may be stacked. The container may again include a first section and second section. In this embodiment, the first or top section may comprise a lid.

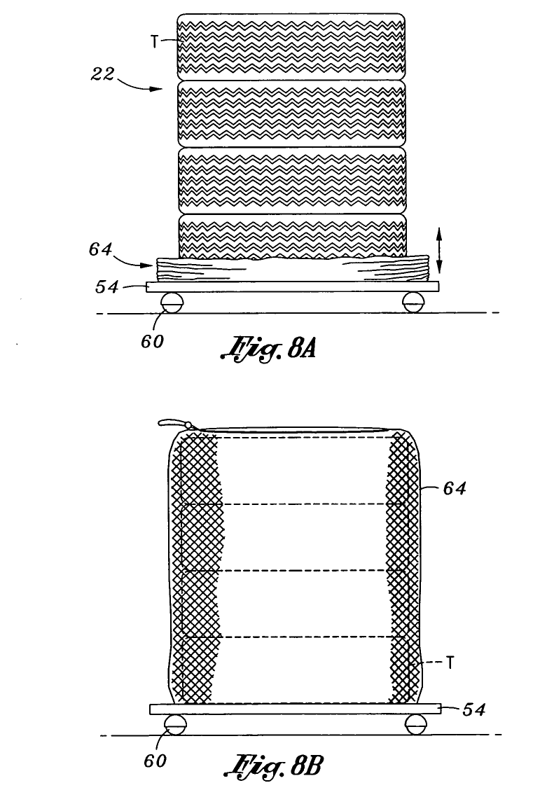

In one embodiment, the containers are substantially rigid. In another embodiment, the container may be made of a pliable material. For example, in one embodiment, the apparatus may comprise a platform 54 upon which the one or more tires may be stacked. As illustrated in FIGS. 8A and 8B, the apparatus may include a generally cylindrical fabric curtain 64 which may be lowered to expose the one or more tires or raised about the one or more tires to obscure or enclose the one or more tires T. The fabric curtain may be, for example, made of a durable woven nylon, canvas or a wide variety of other materials.

In one embodiment, the container or containers need not include wheels. As described above, the container or containers may be transported using a handle or other means.

In one embodiment, each container may be configured so it may be stored in an upright or vertical position. By a generally upright or vertical position it is meant that the container is positioned so that an axis extending through the center of the tire or tires therein is generally parallel to the ground or other support surface, or in other words in generally the same position as a tire when placed on a vehicle.

In this embodiment, multiple containers may be stored by placing generally vertically oriented containers adjacent to one another in a horizontal row. As described above, and as illustrated in FIG. 9, the container 22 may include a planar area 70 or alternatively, feet, legs or other support elements which allow the container to be placed on a support surface in an upright position. In such a configuration, the container may be stored in an upright or vertical position by placing it on a support surface, such as a garage floor, shelf or the like.

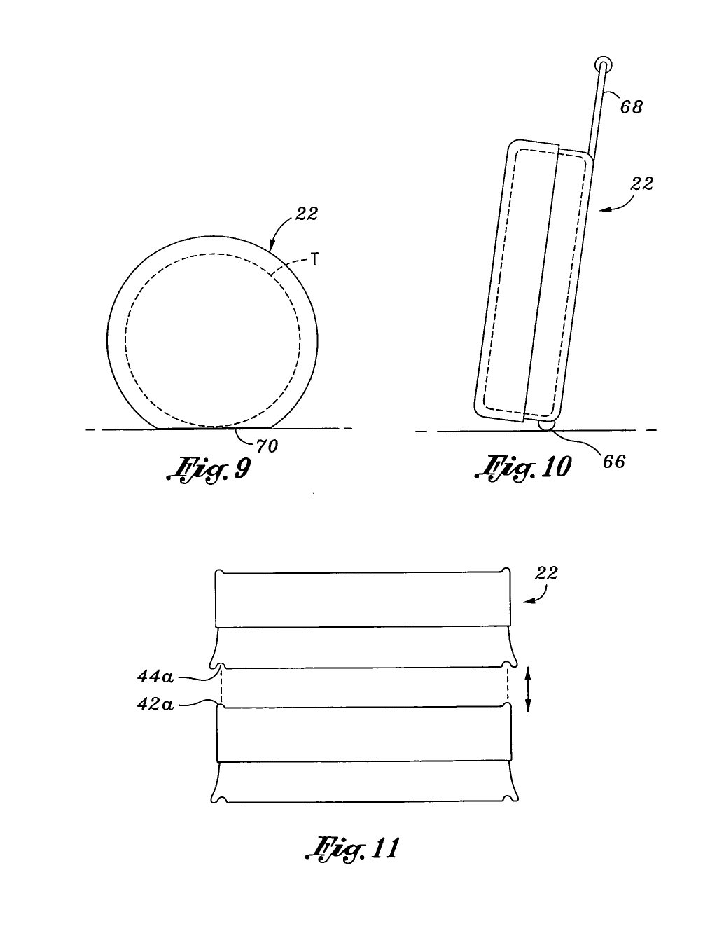

In accordance with this embodiment of the invention, means may be provided for transporting the container in its upright/vertical or substantially upright/vertical position. As indicated above and as illustrated in FIG. 10, such a means may comprise or include a handle 68. As described, the handle 68 may be used to transport the container in “suitcase”-like fashion. In one embodiment, the handle 68 may be retracted when not in use. When in use, the handle 68 may be extended so that the user may pull the container 22 behind them.

In addition, or alternatively, as also illustrated in FIG. 10, the container 22 may include one or more wheels 66, casters or the like. In this embodiment, the wheels 66 may be located on the side of the container 22, such as at the planar portion or the feet, legs or other support elements, instead of the bottom. In one embodiment, wheels 66 may be provided which permit the container to be rolled about in its vertical position. In another embodiment, wheels 66 may be provided which permit the user to tip the container onto the wheels 66 and then roll the container 22. In one or more embodiments, the container may include multiple sets of wheels or casters for moving the container in either its horizontal or vertical position.

It will be appreciated that elements other than wheels may be used. For example, cylindrical or ball rollers may be utilized to permit the container to be transported.

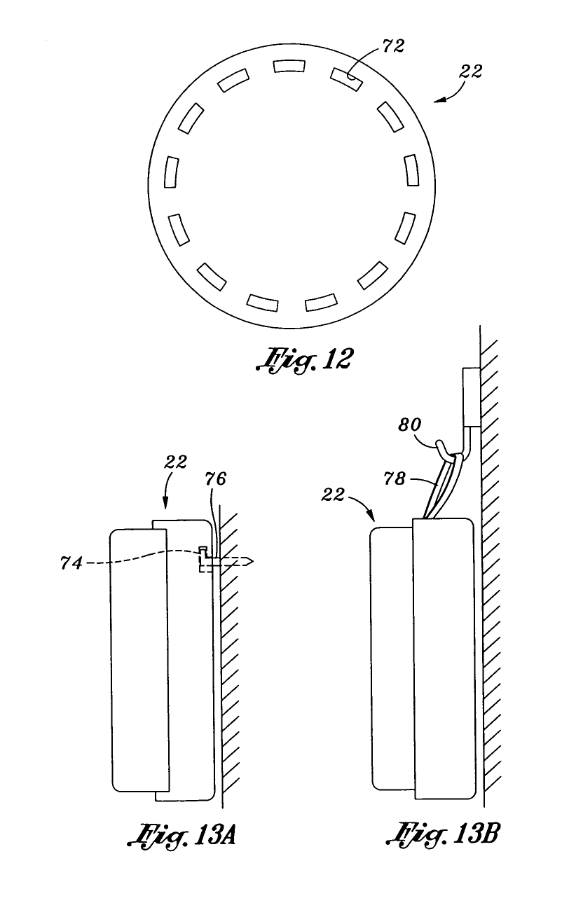

In one embodiment, the container may include means for hanging or mounting the container to another element, such as a wall. In one embodiment, as illustrated in FIG. 13B, the handle may comprise a strap 78 which may be connected to a hook 80 or other element, permitting the container 22 to be hung.

In another embodiment, as illustrated in FIG. 13A, the container may include a slot 74 for accepting a hooking mechanism 76 such as an outwardly extending bolt or other element. The container 22 may be connected to the hooking mechanism 76 or other element, allowing the container to be hung.

In another embodiment, the container may include a mounting element, such as a hanger or hanging element which may be formed in or connected to the container. The hanger may be used to connect the container to another element, such as a hook or the like, again permitting the container to be hung.

In one or more embodiments, the containers may be specifically configured to aid in their transport and storage, such as from a point of manufacture to a point of sale, and from a point of sale to a user's home. In one embodiment, as described above, the first and second sections 24,26 may have different diameters. In this embodiment, the section having the smaller diameter may be inverted and stored within the other section. In this manner the sections may be stacked and occupy less space, such as for transport and display.

In another embodiment, the containers may be of different sizes. For example, the bottom container may be the largest, with each successive container being smaller. In this configuration, the smallest container may be located within the next largest, and so on. The containers thus nest within one another and may all be stored within the largest container (such as the bottom container including wheels or casters). In this embodiment, all of the containers may thus be transported and stored in their empty state while occupying the least amount of space.

In one embodiment, the containers need not completely enclose the tires. For example, as illustrated in FIG. 12, the first and/or second sections of a container 22 may include one or more holes 72 or openings. The holes 72 or openings may be used to permit liquid to drain from the container 22 or to permit the exchange of air.

In one embodiment, the containers may be of a variety of colors, including color coded for use. In the case where the containers are molded of a plastic material, the plastic may be red, black, yellow or a variety of other colors. In the case where the containers are made of other materials, such as fabric, the fabric may be colored. The coloring may be used to designate a size of the container. For example, a container having a first size (such as large for truck wheels) may be black. A container of another size (such as for the tires of a small import car) may be yellow. In this manner, the color coding aids in defining the size of the container and thus the size of tire the container will hold. The color coding may also be used to designate front or rear tire storage. For example, a consumer may utilize a pair of red containers to store their front tires and green containers to store their rear tires. In this manner, the consumer can ensure that the tires are properly placed onto their vehicle at a later time.

As described above, the containers may be constructed of a pliable material such as a fabric. One embodiment of such a container is illustrated in FIGS. 8A and 8B, the container comprising a fabric curtain. This curtain is preferably configured to house or contain multiple tires.

As illustrated in FIG. 14, in one embodiment such a container 122 constructed entirely or partially of a pliable material may be configured to contain as few as one tire. In the embodiment illustrated in FIG. 14, the container 122 has a first section 124 and a second section 126. Means are provided for selectively coupling the first and second sections 124,126 to define a closed or generally closed interior space for housing a tire.

As illustrated, the container 122 is constructed of a durable fabric material and is shaped to fit around or enclose a tire. In one embodiment, the means for coupling comprises a zipper 138. A first half of the zipper is associated with the first section 124 and a second, mating portion of the zipper is associated with the second section 126. In one embodiment, the portions of the zipper 138 are located at or near an edge of the section and designed to meet at a peripheral portion of the container 122.

The zipper may be opened or closed. When opened, the first and second sections 124,126 may be moved away from one another to permit placement of tire therein. When closed, the container 122 surrounds or encloses the tire therein.

In one embodiment, at least a portion of the first and second sections 124,126 are permanently connected to prevent their separation. For example, the zipper 138 need not extend entirely around the edge of the sections 124,126.

Other means may provided for coupling the first and second sections 124,126. For example, hook and loop fastening material may be utilized. For example, hook material may be located about the edge of the first section 124 and mating loop material located about the edge of the second section 126. The material may be in a continuous strip or in spaced segments. Other means for coupling may include buttons, clips, clasps and straps.

In one embodiment, the container 122 may generally have the form of a bag. For example, the container 122 may be closed except at one location. At that location, the first and second sections 124,126 may be opened, such as in the form of a top of a bag, to fit a tire or tires into the container 122. Of course, the size of the opening is selected so that the tire may be placed there through. The bag opening may then be closed, such as with a draw string, zipper or other means for selectively closing. In this configuration, the body forming the container 122 may be constructed as a single element, or of a plurality of individual elements, such as fabric panels which are connected to one another.

As also indicated above, a variety of means may be utilized to connect containers to one another. FIG. 14 illustrates another such means. As illustrated, this means comprises mating hook and loop fastening material. As illustrated, in one embodiment hook or loop material 127 is located on a top portion 128 of the container 122 and hook or loop material 127 is located on a bottom portion 132 of the container. In one embodiment, as illustrated, material 127 is in the form of a generally circular strip of material.

The hook or loop material 127 is configured to mate with corresponding material located on another container 122. In a preferred embodiment, hook material is located on a top portion of each container and loop material on a bottom portion of each container to permit a sequence of containers to connect in a stacked vertical relationship, as illustrated. In another preferred embodiment, loop material is located on a top portion of each container and hook material on a bottom portion of each container to permit a sequence of containers to connect.

Another means for connecting the containers is illustrated in FIG. 14. This means may be used in addition to or separate from the means just described. As illustrated, one or more or each container 122 includes a handle 162. The handle 162 may be a rigid, or may simply comprise a loop of flexible material connected to the container 122. One or more or each container 122 also includes a strap 163. The strap 163 has a first end connected to the container 122 and a second free end. The strap 163 is of sufficient length to permit it to extend and connect to the handle 162 of another container. In one embodiment, the strap 163 includes hook and loop material or other means for connecting which permit the strap 163 to close upon itself to form a closed loop about the handle 162. Other means such as snaps or buckles may be used to close the strap 163 upon itself into a closed loop about the handle 162.

In another embodiment, the strap 163 may be configured to attach to the handle 162 directly, such as with a snap. In another embodiment, each container 122 may include a strap, the straps of mating containers including means for connecting them, such as hook and loop material.

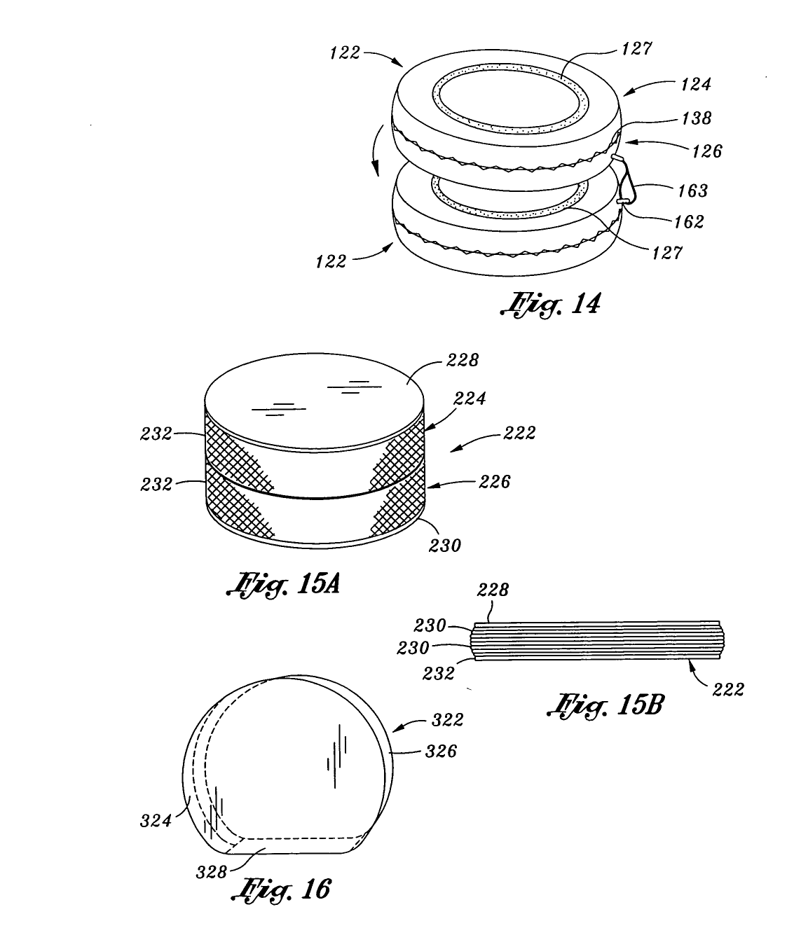

Another embodiment container 222 is illustrated in FIGS. 15A and B. This embodiment container 222 includes a generally rigid and flat top or first member 228 and bottom or second member 230. The top and bottom members 228, 230 may be constructed, for example, of molded plastic. In the embodiment illustrated, the top and bottom members 228,230 are generally rigid, planar plastic discs.

A first section 224 of the container 222 includes the top member 228 and a fabric or other flexible, preferably lightweight material extending therefrom to form a wall 232. Likewise, a second section 226 of the container 222 includes the bottom member 230 and fabric or other flexible, preferably lightweight material extending therefrom to form a wall 232. The first and second sections 224,226 may be configured to couple to one another in the manner described above, such as by a zipper or mating hook and loop material. The material forming the wall 232 may comprise canvas, nylon or a variety of other materials. Preferably, the material is durable and may be expanded and compressed as detailed below.

As illustrated in FIG. 15A, the fabric or other material forming the wall 230 may be extended away from the top and bottom members 228,230 to expand the container 222 to accommodate a tire therein. As illustrated in FIG. 15B, the fabric or other material forming the wall 232 may also be compressed. In that state, the container 222 is generally flat and accommodates storage and transport.

This embodiment container 222 has the advantage that the generally rigid top and bottom portions 228,230 provide structural rigidity to the container 222. The top and bottom portions 228,230 thus provide support, such as when placing the container 222 housing tire on another surface.

At the same time, the fabric or other material forming the walls 232 permits the container to 222 be compressed to a generally flat position, such as when the container 222 is being transported or stored. Also, the fabric material may be expanded so that the container 222 is large enough to house a tire.

Yet another embodiment container 322 is illustrated in FIG. 16. In this embodiment, the container 322 includes a generally planar, rigid base 328. Flexible material, such as fabric, preferably comprises the remainder of the container 322.

In one embodiment, the fabric or other material forms first and second sections 324,326. Means, such as a zipper, hook and loop material or the like preferably permits the first and second sections 324,326 to be connected or disconnected in the manner described above.

The size and shape of the base 328 may vary. The base 328 is preferably configured to provide a stable, flat support for the container 322. In this configuration, the base 328 is actually located at the tread-side of a tire located therein (i.e. the “periphery” of the container), so that the container 322 stores the tire in an upright position.

Like the container 222 illustrated in FIGS. 15A and 15B, the container 322 illustrated in FIG. 16 has the benefit that it may be stored and transported in a collapsed, generally flat state. On the other hand, the fabric material forming the first and second sections 324,326 may be expanded to house a tire, as in the position illustrated in FIG. 16.

It will be appreciated that the device of the invention may include one or more of the above-described features in various combinations other than that specifically described. For example, the container 20 illustrated in FIG. 1 may include a hanger and may be configured to be positioned vertically. Likewise, the containers 122,222,322 may be stored and transported on platform or similar member as illustrated in FIG. 6, and may be stored by hanging as illustrated in FIGS. 13A and 13B. The containers 122,222,322 may also include means for transporting them in a generally upright position, such as a handle as illustrated in FIG. 10.

It will be understood that the above described arrangements of apparatus and the method therefrom are merely illustrative of applications of the principles of this invention and that many other embodiments and modifications may be made without departing from the spirit and scope of the invention as defined in the claims.

1. An apparatus for transporting and storing a plurality of tires comprising:
a plurality of containers, each container comprising a first section and a mating second section, said first section comprising a generally circular base having a wall extending outwardly therefrom, said first section having an inner surface and outer surface, said second section comprising a generally circular base having a wall extending outwardly therefrom, said second section having an inner surface and outer surface, said first and second sections when connected defining a generally enclosed interior area for housing one or more tires therein;
means for connecting said first and second sections of each container;
means for connecting said containers when said containers are stacked upon one another in a vertical arrangement; and
means for rollably supporting said stacked containers.

2. The apparatus in accordance with claim 1 wherein said means for connecting said first and second sections of each container comprises at least one protrusion extending from said inner surface of said wall of said first section and at least one depression in said outer surface of said wall of said second section.

3. The apparatus in accordance with claim 2 wherein said protrusion comprises a generally annular rib and said at least one depression comprises a generally annular trough.

4. The apparatus in accordance with claim 1 wherein said means for connecting said containers comprises at least one protrusion extending from one container and at least one depression in another container for accepting said protrusion.

5. The apparatus in accordance with claim 4 wherein said at least one protrusion comprises a plurality of dimples extending upwardly from said outer surface of said first section of said container.

6. The apparatus in accordance with claim 4 wherein said depression is defined by a recessed central portion of said base of said second section of said container.

7. The apparatus in accordance with claim 1 wherein said wall of said first section has a diameter which exceeds a diameter of said wall of said second section whereby said wall of said first section may be located about the wall of said second section when said first and second sections are connected.

8. The apparatus in accordance with claim 1 wherein said means for rollably supporting comprises a plurality of casters attached to at least one of said containers.

9. The apparatus in accordance with claim 1 wherein said apparatus includes four containers.

10. The apparatus in accordance with claim 9 wherein said means for rollably supporting said containers comprises a plurality of casters attached to one of said four containers.

11. The apparatus in accordance with claim 1 wherein at least one of said containers includes at least one handle.

12. The apparatus in accordance with claim 11 wherein a single handle is connected to and extends from said outer surface of said first or second section of each container.

13. The apparatus in accordance with claim 1 wherein said means for connecting said containers comprises at least one rod extending through said containers.

14. The apparatus in accordance with claim 1 including a platform defining a supporting surface upon which said containers may be stacked, said at least one rod extending upwardly from said supporting surface of said platform.

15. The apparatus in accordance with claim 14 wherein said at least one rod has a first end and a second end, said first end connected to said platform and at least a portion of said second end being externally threaded, said apparatus including a locking member for engaging said threaded portion of said second end of said at least one rod.

16. The apparatus in accordance with claim 1 wherein at least one of said containers includes means for positioning said container in a generally vertical position.

17. The apparatus in accordance with claim 16 wherein said means comprises a generally planar area.

18. The apparatus in accordance with claim 16 including a handle located generally opposite said means for positioning.

19. The apparatus in accordance with claim 1 wherein at least one of said containers includes a hanging element permitting said container to be hung from an element for storage.

20. An apparatus for transporting and storing a plurality of tires comprising:
a plurality of containers, each container comprising a first section and a mating second section, said first section comprising a generally circular base having a wall extending outwardly therefrom, said first section having an inner surface and outer surface, said second section comprising a generally circular base having a wall extending outwardly therefrom, said second section having an inner surface and outer surface, said first and second sections when connected defining a generally enclosed interior area for housing at least one tire therein, a portion of said wall of said first section overlapping with a portion of said wall of said second section, each container having a top and a bottom, said containers stacked upon one another with the bottom of one container resting upon the top of another container, said containers including a connecting mechanism connecting said top of one container and said bottom of an adjacent container.

21. The apparatus in accordance with claim 20 wherein said locking mechanism includes at least one protrusion and at least one mating depression.

22. The apparatus in accordance with claim 21 wherein said at least one protrusion extends from said bottom of each container and said at least one depression is formed in said top of each container.

23. The apparatus in accordance with claim 20 including a mechanism engaging said first and second sections of each container in a connected position.

24. The apparatus in accordance with claim 23 wherein said mechanism comprises a generally annular rib extending outwardly from said inner surface of said first section at said wall thereof and at least one generally annular trough formed on said outer surface of said wall of said second section.

25. The apparatus in accordance with claim 20 wherein said wall of said first section has a greater diameter than said wall of said second section permitting said wall of said first section to be extended about said wall of said second section.

26. The apparatus in accordance with claim 20 wherein each container includes a generally planar section of said wall of said first and second sections for supporting said container in a generally vertical position.

27. The apparatus in accordance with claim 20 wherein each container includes one or more elements extending from at least said first or second section permitting said container to be rested in a generally vertical position.

28. The apparatus in accordance with claim 20 wherein each container includes at least one hanging element permitting said container to be hung from a support element.

29. The apparatus in accordance with claim 20 wherein each container includes at least one handle and at least one wheel positioned to permit a user grasping said handle to transport said container in a generally vertical position by rolling said container upon said at least one wheel.

30. The apparatus in accordance with claim 29 wherein said handle is movable from a retracted position to an extended position.
